(19) United States
(12) Patent Application Publication
(10) Pub. No.: US 2016/0310784 A1
(43) Pub. Date: Oct. 27, 2016

(54) Movement trainer for small animals

(71) Applicant: Dirk Thiele, ROEDERMARK (DE)

(72) Inventor: Dirk Thiele, ROEDERMARK (DE)

(21) Appl. No.: 15/136,080

(22) Filed: Apr. 22, 2016

(30) Foreign Application Priority Data
Apr. 24, 2015 (DE) 102015106327.1

(51) Int. Cl. A63B 22/02; A01K 15/02

(52) U.S. Cl. CPC A63B 22/02; A01K 15/027; A63B 2208/14; A63B 2208/03

(57) ABSTRACT

A movement trainer for small animals has a water basin and a treadmill disposed in the water basin. The water basin has a peripheral side wall that is slanted along a peripheral surface into an interior of the water basin and forms a movement-limiting element for an animal provided in the movement trainer. An open space within the movement-limiting element is smaller than the running surface of the treadmill.

### CROSS-REFERENCE TO A RELATED APPLICATION

The invention described and claimed hereinbelow is also described in German Priority Document DE 10 2015 106 327.1, filed on Apr. 24, 2015. The German Priority Document, the subject matter of which is incorporated herein by reference, provides the basis for a claim of priority of invention under 35 U.S.C. 119(a)-(d).

### BACKGROUND OF THE INVENTION

The invention relates to a movement trainer for small animals, comprising a water basin and a treadmill disposed in the water basin, wherein the water basin has a peripheral side wall.

Movement trainers are used for training, therapy, and convalescence purposes, in particular for restoring or improving the functionality of joints and of the entire organism. Movement trainers are used for relieving pain, building muscle, or for preparing for planned operations on the musculoskeletal system. Movement trainers also are used after an operation for rehabilitation within the framework of a physical therapy program. Movement therapy on a continuous belt in a water basin has particular advantages. As a result of the buoyancy in water, the body's own weight to be supported is substantially less. Low-stress, gentle movement of all joints is ensured.

Hydrotherapy devices for animals, in the case of which a treadmill is disposed in a basin, already are known. DE 20 2006 009 970 U1 describes, for example, a hydrotherapy device for a horse. A treadmill is provided in the water basin, which forces the animal to physically move. The movement is carried out against the resistance of the water. A bar designed as a floating body is disposed transversely in the basin in order to keep the animal at a distance from a front narrow side wall. This training bar sets the desired separation of the animal from the front wall.

Specifically, in the case of small animals, which mainly involves dogs, but also cats, there is an increased interest in possibilities for training the animal in one's own household, since the trips to professional facilities of the type found associated with a veterinarian involve high costs. For that matter, a problem with known movement trainers is that they are typically designed for use with large animals. For home use, such movement trainers are typically associated with high costs and are not transportable. When the known concepts are applied to the unique characteristics of small-animal use, it becomes clear that the restriction of movement by the animal is insufficient. There is always a risk that the animal will impact the side wall with its legs. In order to further limit the freedom of motion of the animal, the animal can be fixed in position using a neck restraint or the like. This can induce stress reactions in the animal situated in the water, however.

### SUMMARY OF THE INVENTION

The present invention overcomes the shortcomings of known arts, such as those mentioned above.

To that end, the present invention provides a movement trainer for small animals, which offers improved movement restriction combined with optimal freedom of movement for the animal during training.

In an embodiment of the inventive trainer, the side wall is slanted, along a peripheral surface, into the interior of the water basin and forms a movement-limiting means for the animal, wherein the open space within the movement-limiting means is smaller than the running surface of the treadmill.

As a result of the features of the inventive trainer, the animal has an optimal amount of open space below the movement-limiting means, in which it can move its extremities with a large degree of freedom. The restriction of movement at the inner side wall is not limited to only one side of the animal, but completely surrounds the animal, because it is likewise designed to extend all the way around and forms a closed movement-limiting means. Preferably, the movement-limiting means extends along the inner side wall, continuously parallel to the running surface. Given that the peripheral side wall forms a continuous movement-limiting means, a larger open space for the animal is available below the movement-limiting means. The open area or the open space available between the movement-limiting means is smaller, in a plane parallel to the running surface, than the running surface of the treadmill.

The movement-limiting means forms a constriction in a vertical direction perpendicular to the running surface. This constriction functions as an optimal movement-limiting means and prevents panic reactions in the animal, since said animal has sufficient open space below the constriction and does not impact the side walls below the movement-limiting means. The movement trainer proves advantageous for dogs, in particular, since precisely these animals can be positioned in such a way that the constriction extends at chest height. The invention may be used advantageously with dogs that are not supposed to swim, but rather are supposed to work against the resistance of the water. Ideally, the movement trainer is designed in different sizes, corresponding to the possible back lengths and the height of the most common breeds of dogs.

Preferably, the side wall of the inventive movement trainer extends from the running surface, along a straight line, and then transitions into the movement-limiting means.

The running surface or the available running surface is defined by the transition of the side walls to the treadmill and characterizes the usable area of the treadmill. The side wall can be composed of multiple side walls, which are joined to form a water basin.

In an embodiment, the side wall along the peripheral surface is bulbously curved into the interior of the water basin. The bulbous or spherical bulge of the movement-limiting means offers the animal comfortable support on each side, which can support the therapy. Therefore, the water basin is designed, proceeding from the running surface in the direction of the basin edge, in such a way that it initially tapers and forms the movement-limiting means. The water basin can be designed in such a way that it subsequently widens again in the direction of the basin edge. Since the side wall widens again in the upward direction after the constriction, the animal has enough space to move its head, which improves the comfort for the animal.

The constriction or movement-limiting means can form an inner surface, which extends perpendicularly to the running surface. This provides comfortable support for the animal.

In another embodiment, the edges of the running surface, as viewed in the vertical direction (perpendicularly to the running surface), are each located outside the inner edge of the movement-limiting means. As a result of this measure, it is ensured that the animal is provided with optimal freedom of movement in every direction. Injuries are prevented as a result. In addition, it is ensured that the animal is situated in a central position.

In another embodiment, the inventive movement trainer provides that opposing sections of the side wall or the side walls that form the peripheral side wall extend, proceeding from the running surface, at an angle of 15°-25° with respect to one another and, in the area of the constriction, extend substantially parallel. In general, the constriction can be a section that has parallel side walls and extends in the vertical direction. This design of the constriction provides the animal with optimal support points, thereby preventing pressure points or injuries. The constriction is ideally adjoined by a section that widens again upwardly, in the vertical direction, i.e., toward the basin edge.

According to the invention, the treadmill is electrically drivable or comprises an electric drive.

In another embodiment, the speed of the treadmill is steplessly variable, which improves the training effect.

In order to simplify the emptying and filling of the water basin, the inventive movement trainer comprises a closable water drain in the base area. Likewise, a preferably closable water inlet can be provided in an upper area or in a lower area, in which case the two inlets can be connected to hoses.

In another embodiment, the slant of the running surface and/or of the treadmill is adjustable. This is implemented, for example, by height-adjustable feet, which are disposed on the underside of the movement trainer and, for example, are screwed in there.

In another embodiment, means are provided for fixing the animal in position and/or relieving the animal in the water basin. In this case, a midsection sling, in particular, which can be fastened on opposite sides of the water basin, is used to support the midsection of the animal.

For the purpose of improving the training effect, another embodiment of the invention provides a pump and at least one nozzle, which is oriented, in the water basin, counter to the running direction. The pump is designed to pump the water from the water basin through the at least one nozzle. This measure provides a counter-current system, in which the nozzle pumps the water against the direction of motion of the animal.

Nozzles also may be used for the purpose of massage. To that end, the inventive movement trainer provides a pump and nozzles that are oriented transversely and/or in the running direction, wherein the pump is designed to pump the water from the water basin through the nozzles. The nozzles functioning as massage nozzles are operated in combination with the counter-current system. In this case, a pump is used both for the nozzles of the counter-current system and for the massage nozzles.

In another embodiment, a heater is provided for warming the water. A pump and a continuous flow water heater is provided for this purpose. The pump or the continuous flow water heater can be combined with the water counter-current system or with the water-massage nozzles such that heated water reaches the animal directly.

In another embodiment, the water basin is designed as a type of tub and is accommodated in a manually transportable outer tub. The outer tub can comprise, in particular, transport handles or the like, which facilitates easier handling. Preferably, the tub is made from plastic and, therefore, from a lightweight material, which makes the movement trainer particularly suitable for home use.

Specifically, in the area of home use, there is a need for training devices for pets, whether if be for wellness purposes, for better physical exertion by the animal or for rehabilitation measures, for example, if a dog would have to protect is musculoskeletal system for a long time. In home use, the water basin is simply filled with tap water. The user can vary this in terms of temperature and level, for example, up to the chest level of the particular dog. The training saves the small-animal owner time-consuming trips to the veterinarian. A transportable training device proves to be particularly advantageous and provides a great deal of flexibility.

In another embodiment, the inventive movement trainer provides sensors, which are designed to ascertain the pressure and/or position of the step by the animal on the running surface. Furthermore, means are provided for transmitting the sensor data to a data processing device.

The sensors are provided underneath the running surface (but not limited to the position). The sensors distributed underneath the running surface make it possible to carry out step-field detection or step-pattern detection, which provides information about the state of the musculoskeletal system of the animal. In addition, the pressure of a dog's paw can be determined, whereby information is obtained when the animal avoids great loads, for example, when the animal limps. The movement trainer comprises corresponding lines, connections or other means for transmitting the sensor data to the data processing device, for example, a computer, a laptop, a tablet, or any other type of suitable device. The data processing device, ideally paired with a display device, such as a monitor or the like, may be provided on the movement trainer.

In another embodiment, the inventive movement trainer comprises means for regulating the water level. Such means can be implemented mechanically or electrically. In the case of a mechanical regulation of the water level, a floating device or the like is provided, which automatically shuts off the water supply at a certain water level, for example, by way of the floating device actuating a valve. In an electrical regulation of the water level, it is possible to integrate different storable levels. To this end, it is possible to use a floating device or any other type of sensor that compares the actual value of the water level with a programmed setpoint value and actuates a corresponding controller, which switches a valve in order to keep the water level at a setpoint level.

### BRIEF DESCRIPTION OF THE DRAWINGS

Further features and advantages of the invention will become apparent from the description of embodiments that follows, with reference to the attached figures, wherein:

FIG. 1 presents a perspective view of an embodiment of a movement trainer of the invention;

FIG. 2 presents a sectional view of the movement trainer depicted in FIG. 1 along the line A-A;

FIG. 3 presents a sectional view of the movement trainer depicted in FIG. 1 along the line B-B;

FIG. 4 presents a top view of the movement trainer depicted in FIG. 1; and

FIG. 5 presents a perspective sectional view of a movement trainer according to another embodiment of the invention.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

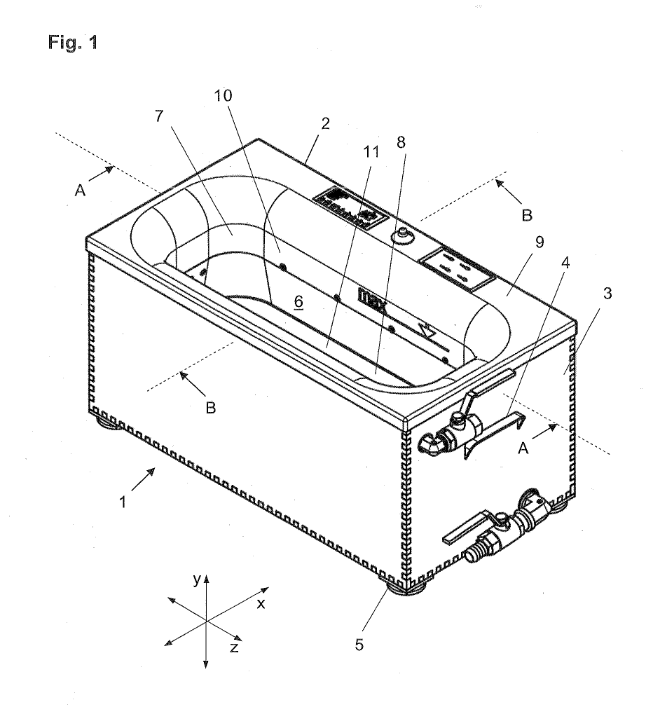

FIG. 1 presents an embodiment of a movement trainer 1 for small animals, for example, dogs, configured in accordance with the invention. The movement trainer comprises a tub-like water basin 2, which is inserted into an outer tub 3. The outer tub 3 is designed in the shape of a box and comprises handles 4 on opposite sides for the easy transport of the movement trainer 1. On the underside of the outer tub 3, the movement trainer 1 has feet 5 in the area of the corners. The feet 5 are height-adjustable, wherein the clearance of the feet 5 from the outer tub 3 is adjustable.

The water basin 2 has an inner basin section 6, which is used to hold the water. The basin section 6 is defined by a peripheral side wall 7 of the water basin. The peripheral side wall 7 extends from a base area, in which a continuous belt or treadmill 8 is disposed, to an upper edge 9 (water basin edge), which is designed so as to be substantially planar. A movement-limiting means 10 is formed in an upper section of the side wall 7. The side wall 7 adjoins the continuous belt 8 in the vertical direction (y-direction). This boundary defines a running surface 11 provided on the treadmill 8. The side wall 7 extends upward in the vertical direction (y-direction) to the upper edge 9. The side wall 7 is slanted, in a direction about the vertical axis Y, into the interior 6 of the water basin 3, along a peripheral surface extending away from the running surface 11, and forms the movement-limiting means 10. The side wall 7 is designed so as to bulge into the interior of the water basin or into the basin section 6 and is correspondingly curved. A construction therefore forms in the middle area. Proceeding from the base area, the tub therefore tapers and becomes narrower up to the constriction (i.e., the movement-limiting means). Following the constriction, the side wall 7 widens and, in the vertical direction (y-direction), forms an outwardly widening section, which transitions into the basin edge 9.

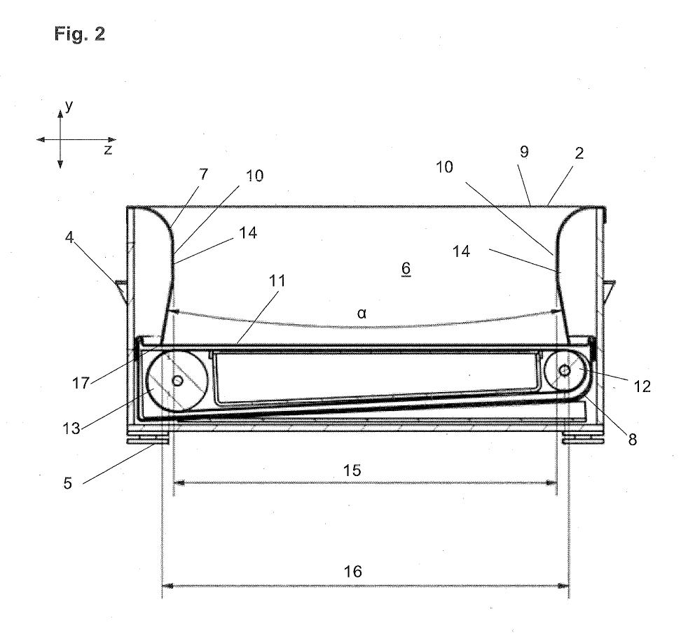

FIG. 2 shows the sectional view A-A of the movement trainer from FIG. 1. The mechanisms for the treadmill 8 are disposed underneath the basin section 6 of the water basin; “treadmill” and “continuous belt” are used interchangeably herein. A box-shaped support for the treadmill is disposed in the base section of the device. The drive comprises a tensioning wheel 12 and a drive wheel 13, via which the treadmill 8 runs. The drive wheel 13 is driven using a non-illustrated motor. The rotational speed of the drive wheel 13 is steplessly adjustable. Adjusting the feet 5 permits the slant of the treadmill 8 or the running surface 11 to be varied such that different slopes can be set.

The movement trainer 1 substantially comprises four inner side walls, specifically two longer, lateral side walls and two opposing, shorter side walls, which correspondingly form the front and the rear side wall, respectively. As shown in FIG. 2, opposing side walls or opposing sections of the side wall 7 are designed in such a way that, proceeding from the running surface 11, they extend upward at an angle of α=20° with respect to one another. Consequently, the side walls transition into the movement-limiting means 10, where they extend substantially parallel until they terminate toward the outside in the manner of a curve. Please note that while the angle α is preferably 20°, this angle limitation may be modified without deviating from the scope and spirit of invention.

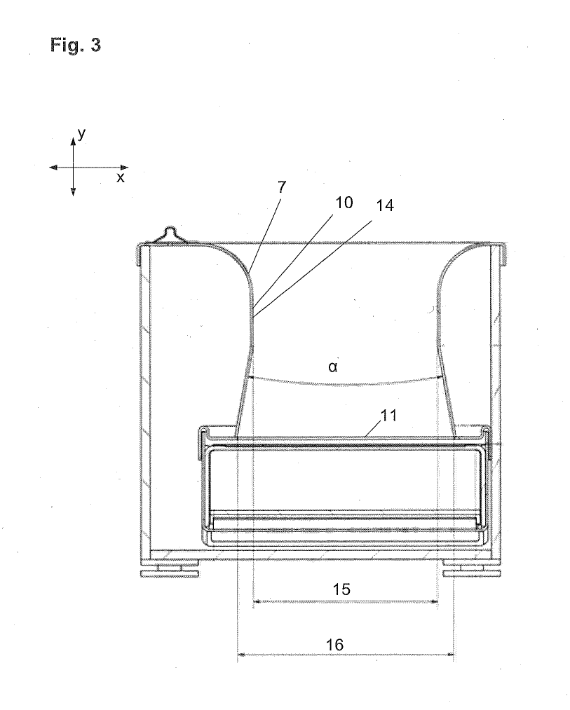

In a plane parallel to the running surface 11, an inner edge 14 of the movement-limiting means 10 defines the available open space. The section 15 between opposing inner edges of the constriction is smaller than the spacing 16 between the edges 17 of the running surface 11. As shown in FIG. 3, this is also the case in the section B-B. In this case as well, the side wall sections, proceeding from a base area, extend upward at an angle of α=20° with respect to one another and then transition into the constriction or the movement-limiting means 10, which also extends vertically upward in the y-direction across a certain extent, wherein the side walls 7 finally terminate upwardly in the manner of a curve. In this case as well, the spacing 15 between the inner edges 14 of opposing side wall sections is less than the spacing 16 of the running-surface limitation at the edges 17 in the base. Therefore, the movement-limiting means 10 is adjoined both toward the top and toward the bottom by outwardly widening sections.

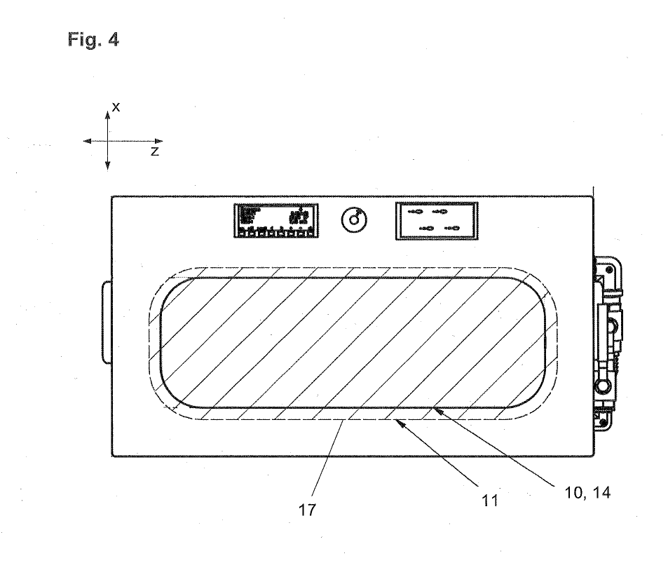

A detailed movement-limiting means 10 is shown in FIG. 4. Dashed lines indicate the available running surface 11 and the inner edge 14 of the movement-limiting means 10. It is apparent that the surface area of the running surface 11 is larger than the surface area of the available open space within the movement-limiting means 10. As a result, the animal has optimal possibilities for moving in all directions, but is simultaneously limited in terms of his freedom of movement. As viewed from above, the edges of the running surface 10 are located outside the inner edge 14 of the movement-limiting means 10.

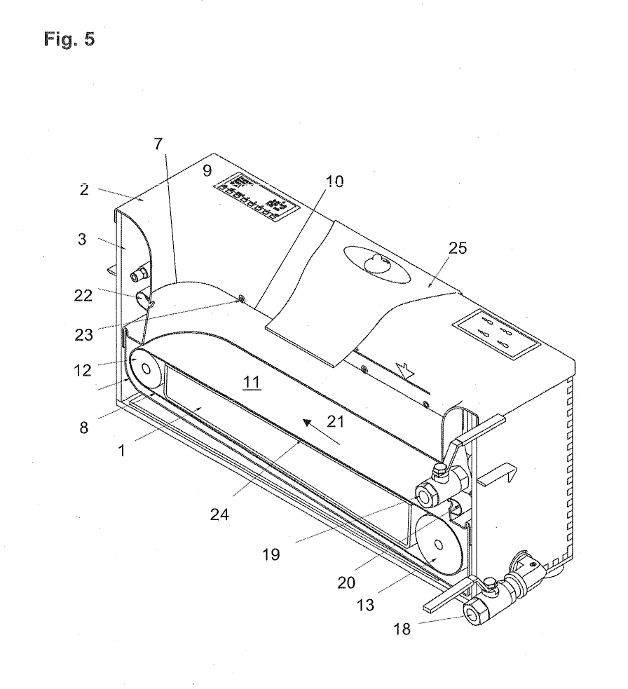

FIG. 5 shows another embodiment of inventive movement trainer 1 that includes several additional options, which improve the performance of the movement trainer 1. That is, the FIG. 5 embodiment comprises a drain valve 18, which is connected to the basin section 6.

An inlet water tap 19 also is provided, via which water can be introduced into the movement trainer 1. An optional suction filter 20 protects certain functions of the movement trainer 1. That is, in an embodiment, the water within the basin section 6 can be sucked up by the pump in order to let it out again into the basin section via the nozzles 22 or massage nozzles 23. The filter 20 protects the nozzles 22, 23 from pollution within the water, for example from dirt from the dog. Counter-current nozzles 22 are disposed in the side wall 7, counter to the running direction 21 of the animal (the running surface 11 moves under the animal in the opposite direction). The counter-current nozzles 22 are fluidically connected to a non-illustrated pump, wherein the pump pumps water from the basin section 6 to the nozzles 22. In the same manner, the pump is connected to massage nozzles 23, which are provided in lateral sections of the side wall 7.

Sensors 24, which measure the pressure of the steps of the animal during walking, are distributed underneath the running surface 11. The sensors are distributed in such a way that a movement pattern can be registered and can be evaluated by a data processing device.

A midsection sling 25 is detachably fastened at the upper area of the upper edge 9. This midsection sling can be placed under the midsection of the particular animal, which is thereby supported in the vertical direction. The therapy effect is supported as a result.

### LIST OF REFERENCE NUMBERS

1 movement trainer
2 water basin
3 outer tub
4 handle
5 foot
6 basin section
7 side wall
8 continuous belt
9 upper edge (basin edge)
10 movement-limiting means (constriction)
11 running surface
12 tensioning wheel
13 drive wheel
14 inner edge
15 spacing
16 spacing
17 edge of the running surface
18 drain valve
19 inlet water tap
20 suction filter
21 running direction
22 counter-current nozzle
23 massage nozzle
24 pressure sensors
25 midsection sling

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A movement trainer for small animals, comprising:
a water basin including a peripheral sidewall;
a treadmill disposed in the water basin formed with a running surface;
wherein the peripheral side wall is slanted along a peripheral surface into an interior of the water basin and forms a movement-limiting means for an animal provided therein for training; and
wherein the movement-limiting means an open space that is smaller than the running surface of the treadmill.

2. The movement trainer according to claim 1, wherein the peripheral side wall is bulbously curved into the interior of the water basin.

3. The movement trainer according to claim 1, wherein the movement-limiting means forms a surface extending perpendicularly to the running surface of the treadmill.

4. The movement trainer according to claim 3, wherein edges of the running surface are located outside an inner edge of the movement-limiting means.

5. The movement trainer according to claim 1, wherein opposing sections of the peripheral side wall extend, proceeding from the running surface, at an angle of 15 to 25° with respect to one another and extend substantially in parallel in an area of the movement-limiting means.

6. The movement trainer according to claim 1, wherein the water basin widens in a vertical direction, extending away from the movement-limiting means, toward a basin edge.

7. The movement trainer according to claim 1, wherein a slant of the running surface is adjustable.

8. The movement trainer according to claim 1, further comprising a pump and at least one nozzle oriented counter to a running direction, wherein the pump pumps water from the water basin through the at least one nozzle.

9. The movement trainer according to claim 1, further comprising a pump and at least one nozzle oriented transversely, oriented in a running direction or oriented both transversely and in a running direction, wherein the pump pumps water from the water basin through the at least one nozzle.

10. The movement trainer according to claim 1, further comprising a continuous flow water heater for heating water.

11. The movement trainer according to claim 1, wherein the water basin is designed as a tub that is positionable within and manually transportable by an outer tub, wherein the outer tube is fitted with handles.

12. The movement trainer according to claim 1, further comprising sensors for ascertaining a pressure of a step of an animal provided in the movement trainer on the running surface, a position of a step of an animal provided in the movement trainer on the running surface, or both; and means for transmitting the sensor data to a data processing device.

13. The movement trainer according to claim 1, further comprising means for regulating a level of water in the water basin.
